(19) United States
(12) Patent Application Publication
(10) Pub. No.: US 2003/0069783 A1
(43) Pub. Date: Apr. 10, 2003

(54) System and method for electronic voting

(75) Inventor: Hiroki Homma, Tokyo (JP)

Correspondence Address: SUGHRUE MION, PLLC, 2100 PENNSYLVANIA AVENUE, N.W., WASHINGTON, DC, 20037, US

(73) Assignee: NEC CORPORATION

(21) Appl. No.: 10/265,359

(22) Filed: Oct. 7, 2002

(30) Foreign Application Priority Data
Oct. 5, 2001 (JP) 2001-310105

(51) Int. Cl. G06F 17/60

(52) U.S. Cl. 705/12

(57) ABSTRACT

An electronic voting system for use in an election makes it possible to simply find out unlawfulness in voting or election at low cost and to prevent unlawful or dishonest voting, and man-made mistakes and data falsification in an election administration commission, thereby providing fair vote counting results. This system comprises a voting terminal operably configured to permit a voter to cast a vote and a voting process execution subsystem connected to the voting terminal. The voting process execution subsystem receives voting information of the vote sent from the voting terminal for vote counting operation. A validation subsystem, which is connected to the voting terminal, requests the voter to confirm the voting information of his/her own vote, thereby judging validity of the vote. Preferably, the voting process execution subsystem offers the voter to send the voting information to the voting process execution subsystem by electronic mail or at a site on the Internet, selectively.

### BACKGROUND OF THE INVENTION

1. Field of the Invention

The present invention relates generally to a system and a method for electronic voting. More particularly, the invention relates to an electronic voting system and an electronic voting method for use in an election, in which voters cast their votes electronically by way of a communications network. The system and method make it possible to simply find out unlawful voting at low cost or expenses.

2. Description of the Related Art

Conventionally, in elections for members of the Diet or Congress and for members of municipalities assemblies (e.g., city, towns and village assemblies), voters go to the designated polling booths or stations, receive voting papers or ballots after validating or authenticating the voters' identities with the use of an electoral register, write down the name of selected candidates on the voting papers, and put the voting papers into the ballot boxes. After the specific voting period is completed, specific persons in charge of ballot counting operations open the ballet boxes and count the votes for each candidate by hands. These behaviors are typical ones that have ever seen in elections.

With the above-described conventional election systems, there is a drawback that voters must go to assigned or designated polling places and that the vote counting operations by hands require significant time and manpower. To eliminate this drawback, “electronic voting systems” have been developed, where voters cast their votes electronically with their private terminals or computers, or with public voting terminals or stations located at specified places by way of a communications network.

Generally, with electronic voting systems for enabling voters to cast their votes electronically by way of their operations at the voting terminals or stations, unlawful or dishonest voting conducted by others, and man-made mistakes and/or data falsification occurring in an election administration commission must be prevented. To fulfill this requirement, strong or hard security systems are necessary to conduct strict data management and procedures check. This means that cost reduction during operation or management is difficult. Moreover, it is not easy to find out unlawfulness and to judge the validity of votes simply and objectively.

### SUMMARY OF THE INVENTION

Accordingly, an object of the present invention is to provide an electronic voting system and an electronic voting method for use in an election that make it possible to simply find out unlawfulness in an election at low cost.

Another object of the present invention is to provide an electronic voting system and an electronic voting method for use in an election that make it possible to prevent unlawful or dishonest voting, and man-made mistakes and data falsification in an election administration commission, thereby providing fair vote counting results.

The above objects together with others not specifically. mentioned will become clear to those skilled in the art from the following description.

According to a first aspect of the present invention, an electronic voting system for use in an election is provided. This system comprises:

a voting terminal operably configured to permit a voter to cast a vote; and

means for feeding back a content of the vote cast by the voter to the said voter and for requesting the said voter to confirm or verify the content of the vote.

With the electronic voting system according to the first aspect of the present invention, the means for feeding back a content of the vote cast by the voter to the said voter and for requesting the said voter to confirm or verify the content of the vote is provided and therefore, the content of the vote, i.e., the validity of the vote, can be confirmed or verified. Thus, unlawfulness in voting or an election can be simply found out at low cost.

Moreover, because unlawfulness in voting can be found out, unlawful or dishonest voting, and man-made mistakes and data falsification in an election administration commission can be prevented. This means that fair vote-counting results are obtainable.

According to a second aspect of the present invention, another electronic voting system for use in an election is provided. This system comprises:

a voting terminal operably configured to permit a voter to cast a vote;

a voting process execution subsystem connected to the voting terminal;

the voting process execution subsystem receiving voting information of the vote sent from the voting terminal for vote counting operation;

a validation subsystem connected to the voting terminal; and

the validation subsystem requesting the voter to confirm the voting information of his/her own vote sent from the voting terminal, thereby judging validity of the vote.

With the electronic voting system according to the second aspect of the present invention, a validation subsystem connected to the voting terminal is provided, where the validation subsystem requests the voter to confirm the voting information of his/her own vote sent from the voting terminal, thereby judging validity of the vote. Therefore, the content of the vote, i.e., the validity of the vote, can be confirmed or verified by the voter himself/herself. Thus, unlawfulness in voting or election can be simply found out at low cost.

Moreover, because unlawfulness in voting or election can be found out, unlawful or dishonest voting, and man-made mistakes and data falsification in an election administration commission can be prevented. This means that fair vote-counting results are obtainable.

In a preferred embodiment of the system according to the second aspect of the invention, the voting process execution subsystem sets a voting identification and a voting password of the voter and notifies the voting identification and the voting password thus set to the voter. The validation subsystem sets a confirmation identification and a confirmation password of the voter and notifies the confirmation identification and the confirmation password thus set to the voter. Voting information of the voter is sent from the voting terminal to the voting process execution subsystem using the voting identification and the voting password. Confirmation information of the voter is sent from the voting terminal to the validation subsystem using the confirmation identification and the confirmation password in response to request by the validation subsystem to confirm his/her own voting information.

In this embodiment, preferably, the voting process execution subsystem offers the voter to send the voting information to the voting process execution subsystem by electronic mail or at a site with a specific URL (Uniform Resource Locator) on the Internet, selectively. An advertisement may be displayed at the site with the specific URL.

According to a third aspect of the present invention, still another electronic voting system for use in an election is provided. This system comprises:

voting terminals operably configured to permit voters to cast votes;

a voting process execution subsystem connected to the voting terminals;

the voting process execution subsystem receiving information of the votes sent from the voting terminals for vote counting operation;

a validation subsystem connected to the voting terminals;

the validation subsystem confirming the voting information of the votes, thereby judging validity of the votes;

a voting request management subsystem for requesting the voting process execution subsystem and the validation subsystem to execute voting process and validation process, respectively, and for receiving vote counting results and vote validation results from the voting process execution subsystem and the validation subsystem, respectively;

a database for storing vote-relating information including data about eligible voters;

the database being accessible by the voting process execution subsystem, the validation subsystem, and the voting request management subsystem.

With the electronic voting system according to the third aspect of the present invention, a validation subsystem, a voting request management subsystem, and a database for storing vote-relating information are provided. The validation subsystem confirms the voting information of the votes, thereby judging validity of the votes. The voting request management subsystem requests the voting process execution subsystem and the validation subsystem to execute voting process and validation process, respectively, and receives vote counting results and vote validation results from the voting process execution subsystem and the validation subsystem, respectively. The database, which is accessible by the voting process execution subsystem, the validation subsystem, and the voting request management subsystem, stores vote-relating information including data about eligible voters. Therefore, the content of the votes, i.e., the validity of the votes, can be confirmed or verified by the voters themselves. Thus, unlawfulness in voting or election can be simply found out at low cost.

Moreover, because unlawfulness in voting or election can be found out, unlawful or dishonest voting, and man-made mistakes and data falsification in an election administration commission can be prevented. This means that fair vote-counting results are obtainable.

According to a fourth aspect of the present invention, an electronic voting method for use in an election is provided. This method comprises the steps of:

notifying a voter to cast his/her vote from a voting terminal;

receiving voting information of a vote sent from the voting terminal; and

requesting the voter to confirm the voting information of his/her own vote sent from the voting terminal, thereby judging validity of the vote.

With the electronic voting method according to the fourth aspect of the present invention, a voter is notified to cast his/her vote from a voting terminal and voting information of a vote sent from the voting terminal is received. The voter is requested to confirm the voting information of his/her own vote sent from the voting terminal, thereby judging validity of the vote. Therefore, unlawfulness in voting or election can be simply found out at low cost.

Moreover, because unlawfulness in voting or election can be found out, unlawful or dishonest voting, and man-made mistakes and data falsification in an election administration commission can be prevented. This means that fair vote-counting results are obtainable.

In a preferred embodiment of the method according to the fourth aspect of the invention, the following steps are additionally carried out. Specifically, (i) a voting identification and a voting password of the voter are set and the voting identification and the voting password thus set are notified to the voter. (ii) A confirmation identification and a confirmation password of the voter are set and the confirmation identification and the confirmation password thus set are notified to the voter. (iii) Voting information of the voter is sent from the voting terminal to a voting process execution subsystem using the voting identification and the voting password. (iv) Confirmation information of the voter is sent from the voting terminal to a validation subsystem using the confirmation identification and the confirmation password in response to request by the validation subsystem to confirm his/her own voting information.

In this embodiment, preferably, the voter is offered to send the voting information by electronic mail or at a site with a specific URL on the Internet, selectively. An advertisement may be displayed at the site with the specific URL.

### BRIEF DESCRIPTION OF THE DRAWINGS

In order that the present invention may be readily carried into effect, it will now be described with reference to the accompanying drawings.

FIG. 1 is a functional block diagram showing the configuration of an electronic voting system according to an embodiment of the present invention.

FIG. 2 is a schematic diagram showing the operation of the electronic voting system according to the embodiment of FIG. 1.

FIG. 3 is a schematic diagram showing an image displayed on the screen of a voting terminal used in the electronic voting system according to the embodiment of FIG. 1, in which the image of a web site on the Internet is shown.

### DETAILED DESCRIPTION OF THE PREFERRED EMBODIMETNS

Preferred embodiments of the present invention will be described in detail below while referring to the drawings attached.

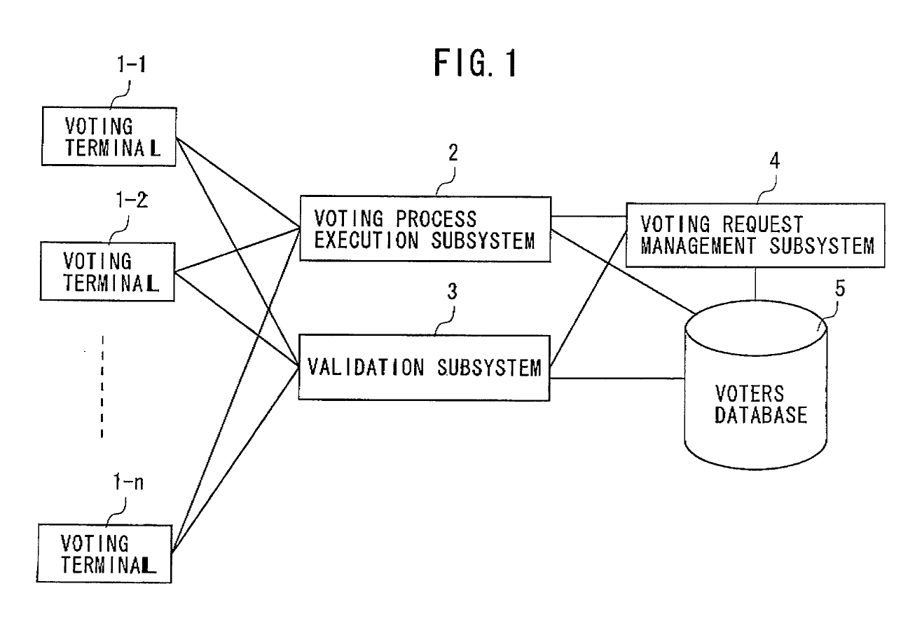

An electronic voting system according to an embodiment of the invention has the configuration shown in FIG. 1, which is used for an election.

As shown in FIG. 1, the electronic voting system according to the embodiment comprises n voting terminals 1-1, 1-2, . . . , 1-n, a voting process execution subsystem 2, a validation subsystem 3, a voting request management subsystem 4, and a database 5. The voting terminals 1-1 to 1-n are connected (or connectable if necessary) with these subsystems 2, 3 and 4 by way of a communications network. Usually, the terminals 1-1 to 1-n are remote from the subsystems 2, 3 and 4. The subsystems 2, 3 and 4, which are electrically connected to each other, are connected to the database 5 for information retrieval.

The voting process execution subsystem 2, the validation subsystem 3, and the voting request management subsystem 4 may be actually constituted on a single computer system or on separate computer systems, or the like.

Each of the voting terminals 1-1 to 1-n is operably configured to permit a voter to cast a ballot or vote.

The voting process execution subsystem 2, which is connected to the voting terminals 1-1 to 1-n by way of the network, receives the voting information of the votes sent from the voting terminals 1-1 to 1-n and conducts the vote counting operation using the information thus received.

The validation subsystem 3, which is connected to the voting terminals 1-1 to 1-n by way of the network, confirms the voting information of the votes, thereby judging the validity of the votes or the voting results.

The voting request management subsystem 4 requests the voting process execution subsystem 2 and the validation subsystem 3 to execute specific voting processes and specific validation processes, respectively, thereby conducting the voting management.

The database 5 stores the vote-relating information including the data about eligible voters lists. The database 5 is accessible for data retrieval by the voting process execution subsystem 2, the validation subsystem 3, and the voting request management subsystem 4.

Typically, each of the terminals 1-1 to 1-n is actually constituted by a personal computer or a portable telephone (i.e., a cellular phone) or the like a voter possesses. Alternately, each of the terminals 1-1 to 1-n is constituted by a commonly-used (or public) terminal or computer located at a specific polling booth or station.

The voting process execution subsystem 2 receives a request for conducting the electronic voting processes from the voting request management subsystem 4. In response to this request, the subsystem 2 sets or creates a voting identification (ID) and a voting password (PW) for each of the voters based on the eligible voters list stored in the database 5. Thereafter, the subsystem 2 notifies the voting ID and the voting PW thus set and other relating information such as the voting way to each of the voters by way of the network. On the other hand, the subsystem 2 receives the voting information (i.e., the voting content (e.g., the name of a candidate selected), the voting ID, and the voting PW) from the voters and counts them. After the voting is completed, the subsystem 2 notifies the voting result to the voting request management subsystem 4.

The validation subsystem 3 receives a request for conducting the validation processes from the voting request management subsystem 4. In response to this request, the subsystem 3 sets or creates a confirmation ID and a confirmation PW for each of the whole voters or the specified voters chosen optionally. Thereafter, the subsystem 3 feeds back the contents of the votes to the corresponding voters by way of the network before or after announcing or disclosing the voting results, thereby requesting the corresponding voters to confirm the contents of their votes. In response to this request, the voters send the confirmation results to the subsystem 3. Based on the confirmation results thus sent from the voters, the subsystem 3 evaluates and judges the validity of the votes (i.e., whether the votes are valid or not). Then, the subsystem 3 notifies the judgment results to the respective voters and the voting request management subsystem 4.

The request for conducting the voting validation to a voter is to confirm or check whether the content of a vote transmitted by a voter from a voting terminal is correct or not, and to send back the result of the confirmation or check to the voting request management subsystem 4.

The above-identified notifications or messages about the vote-relating information to be transmitted to a voter are sent by electronic mail or traditional mail. If the electronic mail address of a voter is registered in advance, these notifications or messages are sent to the voter by electronic mail. On the other hand, if the electronic mail address of a voter is not registered, they are sent to the voter by traditional mail.

The voting process execution subsystem 2 offers the voters to send the voting information and/or the confirmation results to the subsystem 2 by electronic mail or at a web site with a specific URL (Uniform Resource Locator) on the Internet, selectively. The electronic mail address and the URL for accessing the voting process execution subsystem 2 and the validation subsystem 3 are notified to the voters before an election is started.

An advertisement may be displayed at the web site with the specific URL.

If a voter whose electronic mail address is not registered has a hope or intention to receive the request for confirming the vote from the validation subsystem 3 by electronic mail, the voter needs to inform the subsystem 3 of his/her electronic mail address in advance. Such item is notified to the voters along with the voting and confirmation IDs and the voting and confirmation PWs.

Actually, for example, each of the voting process execution subsystem 2, the validation subsystem 3, and the voting request management subsystem 4 may be formed by a computer or part of a computer system.

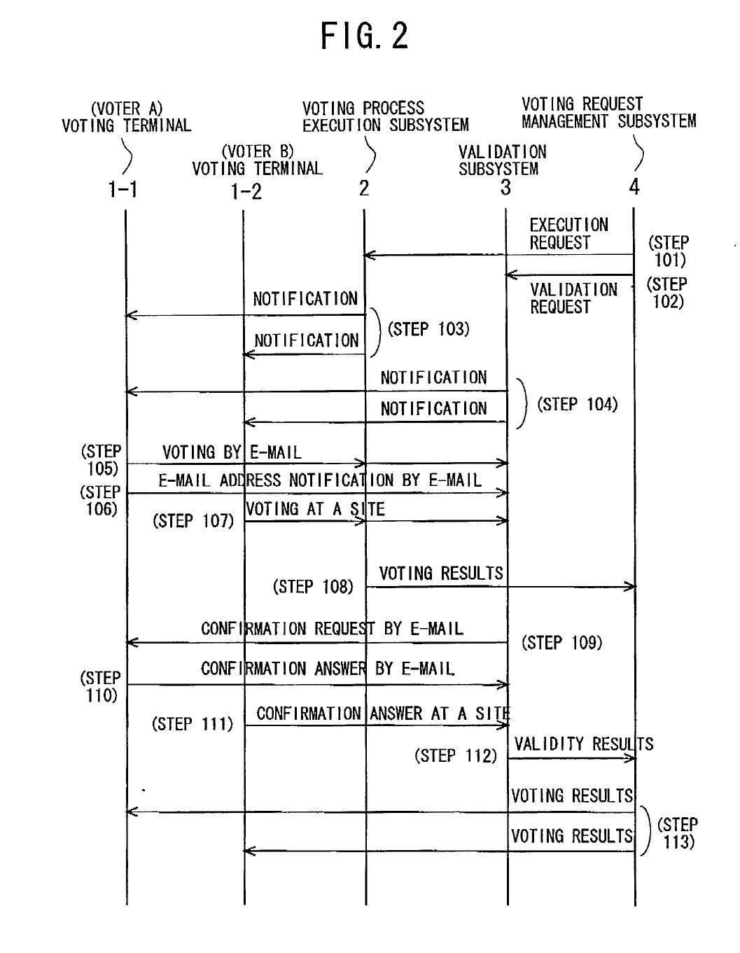

Next, the operation of the electronic voting system according to the embodiment having the above-described configuration is explained below with reference to FIG. 2. In the following explanation of the operation, it is supposed that only two voting terminals 1-1 and 1-2 are respectively used by two voters A and B. This is for the sake of simplification of explanation.

First, to carry out an electronic voting in an election, the voting request management subsystem 4 requests the voting process execution subsystem 2 to execute the specific voting processes (Step 101). Moreover, the subsystem 4 requests the validation subsystem 3 to execute the specific validation processes (Step 102).

When receiving the request to execute the specific voting processes from the voting request management subsystem 4, the voting process execution subsystem 2 sets or creates a voting ID and a voting PW for each of the voters A and B based on the eligible voters list stored in the database 5. Furthermore, the subsystem 2 determines the user interface and the voting way for the voters A and B. Thereafter, the subsystem 2 notifies the voting ID and the voting PW thus set and the other necessary information including the user interface and the voting way to each of the voters A and B (Step 103).

On the other hand, when receiving the request to conduct the specific validation processes from the voting request management subsystem 4, the validation subsystem 3 sets or creates a confirmation ID and a confirmation PW for each of the voters A and B. Furthermore, the subsystem 3 determines the confirmation or validation way for the voters A and B. Thereafter, the subsystem 3 notifies the confirmation ID and the confirmation PW thus set and the validation way to each of the voters A and B (Step 104).

If the electronic mail address of the voter A or B is registered in advance, the notifications from the voting process execution subsystem 2 and the validation subsystem 3 are transmitted to the voter A or B by electronic mail. If the electronic mail address of the voter A or B is not registered, the notifications from the voting process execution subsystem 2 and the validation subsystem 3 are sent to the voter A or B by traditional mail (not electronic mail).

Here, for example, it is supposed that the electronic mail addresses of the voters A and B are not registered, and that the voter A has selected the electronic voting and the voting confirmation by way of electronic mail and the voter B has selected the electronic voting and voting confirmation at a specific web site with a specific URL on the Internet.

The voter A operates or controls the voting terminal 1-1 by a specific due date in response to the notification from the voting process execution subsystem 2, thereby transmitting by electronic mail his/her voting information in a specified format to the voting process execution subsystem 2 using his/her voting ID and voting PW (Step 105).

Since the voter A has selected the voting confirmation by way of electronic mail, the voter A notifies his/her electronic mail address to the validation subsystem 3 by electronic mail (Step 106).

On the other hand, the voter B has selected the electronic voting at a specific web site with a specific URL. Therefore, in response to the notification from the voting process execution subsystem 2, the voter B operates or controls the voting terminal 1-2 to access the specified web site by a specific due date using his/her voting ID and voting PW. Then, the voter B inputs his/her voting information into a specified area on the display screen of the terminal 1-2 (Step 107).

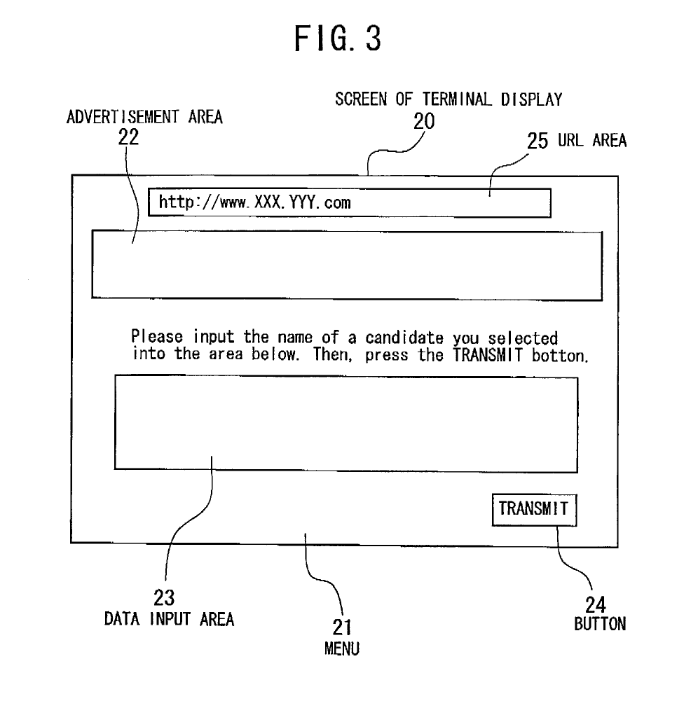

FIG. 3 shows an image displayed on the screen of the voting terminal 1-2, in which the image of a web site on the Internet is shown. In FIG. 3, a voting menu 21 is partially displayed on the screen 20 of the terminal 1-2. The menu 21 comprises an advertisement area 22, a data input area 23, a “TRANSMIT” button 24, and a URL area 25. An advertisement is displayed in the area 22. The URL of the site displayed on the screen 20 is shown in the area 25.

The voter B inputs the name of a candidate he/her has selected into the data input area 23 with the keyboard of the terminal 1-2 and then presses the “TRANSMIT” button 24 with the mouse, thereby transmitting the voting information.

Unlike the voter A, the voter B has selected the voting confirmation at the web site. Therefore, the voter B needs not to notify his/her electronic mail address to the validation subsystem 3.

The voting information of the voters A and B thus inputted is simultaneously transmitted to the voting process execution subsystem 2 and the validation subsystem 3 by way of a mailing list or the like.

The voting process execution subsystem 2 counts the votes for each candidate and notifies the voting result to the voting request management subsystem 4 (Step 108).

The validation subsystem 3 creates a menu for confirmation to be displayed on the same web site as used for voting, based on the voting information sent from the voters. The confirmation menu is like the voting menu shown in FIG. 3. The subsystem 3 requests the voters who have selected the confirmation by electronic mail to conduct the confirmation processes.

Since the voter A has selected the confirmation by electronic mail, the validation subsystem 3 requests the voter A to conduct the confirmation operation by electronic mail (Step 109).

After receiving the request for confirmation from the validation subsystem 3, the voter A operates the voting terminal 1-1 to input his/her confirmation ID and confirmation PW and the confirmation result into a specified form, and transmits them to the subsystem 3 by electronic mail (Step 110).

On the other hand, since the voter B has selected the voting confirmation at the web site, the voter B operates the voting terminal 1-2 to access the designated web site for confirmation with a specific URL using his/her confirmation ID and confirmation PW. This operation needs to be completed by the due date designated by the notification from the validation subsystem 3. Then, the voter B inputs his/her confirmation result into the specified area in the confirmation menu displayed on the terminal 1-2, and transmits it to the validation subsystem 3 from the site (Step 111).

The validation subsystem 3 makes voting statistics based on the voting confirmation results received within the designated period, and notifies the validation results that express the judgment result on the validity of the votes to the voting request management subsystem 4 (Step 112).

The voting request management subsystem 4 receives the voting results and the validation or confirmation results from the voting process execution subsystem 2 and the validation subsystem 3, respectively. Thereafter, the subsystem 4 discloses or announces them to the voters by way of the network (Step 113).

With the electronic voting system according to the embodiment of the present invention, as described above, the validation subsystem 3, the voting request management subsystem 4, and the database 5 are provided in addition to the voting process execution subsystem 2. The validation subsystem 3 confirms the voting information of the votes, thereby judging validity of the votes. The voting request management subsystem 4 requests the voting process execution subsystem 2 and the validation subsystem 3 to execute the voting processes and the validation processes, respectively, and receives the vote counting results and the vote validation results from the voting process execution subsystem 2 and the validation subsystem 3, respectively. The database 5, which is accessible by the voting process execution subsystem 2, the validation subsystem 3, and the voting request management subsystem 4, stores the vote-relating information including the data about the eligible voters list.

Therefore, the content of the votes, i.e., the validity of the votes, can be confirmed or verified by the voters themselves. Thus, unlawfulness in voting or election can be simply found out at low cost.

Moreover, because unlawfulness in voting or election can be found out simply, unlawful or dishonest voting, and man-made mistakes and data falsification in an election administration commission can be prevented. This means that fair vote-counting results are obtainable.

Furthermore, in response to the request for confirming the contents of the votes from the voting request management subsystem 4, each of the voters can answer the request by operating any one of the voting terminals 1-1 to 1-n using his/her confirmation ID and confirmation PW that have been given in advance. Therefore, the voters do not have the necessity to possess their own voting terminals. Since private portable telephones (i.e., cellular phones) may be used for this purpose, there is an additional advantage that the voters can conduct their confirmation processes any time from anywhere even outside their homes if the conduct is made within the specified or designated confirmation period.

If the voters conduct the voting and confirmation processes or operations at the specific web site on the Internet (e.g., a portal site), an advertisement may be displayed on the same site. In this case, there arises an additional advantage that the expenses or costs for conducting the electronic voting (i.e., operating the electronic voting system) can be collected partially or entirely.

### VARIATIONS

Needless to say, the present invention is not limited to the above-described embodiment, because it is a preferred example of the invention. Any change or modification may be added to it within the spirit of the invention.

While the preferred form of the present invention has been described, it is to be understood that modifications will be apparent to those skilled in the art without departing from the spirit of the invention. The scope of the present invention, therefore, is to be determined solely by the following claims.

What is claimed is:

1. An electronic voting system for use in an election, comprising:
a voting terminal operably configured to permit a voter to cast a vote; and
means for feeding back a content of the vote cast by the to the said voter and for requesting the said voter to confirm or verify the content of the vote.

2. An electronic voting system for use in an election, comprising:
a voting terminal operably configured to permit a voter to cast a vote;
a voting process execution subsystem connected to the voting terminal;
the voting process execution subsystem receiving voting information of the vote sent from the voting terminal for vote counting operation;
a validation subsystem connected to the voting terminal; and
the validation subsystem requesting the voter to confirm the voting information of his/her own vote sent from the voting terminal, thereby judging validity of the vote.

3. The system according to claim 2, wherein the voting process execution subsystem sets a voting identification and a voting password of the voter and notifies the voting identification and the voting password thus set to the voter;
and wherein the validation subsystem sets a confirmation identification and a confirmation password of the voter and notifies the confirmation identification and the confirmation password thus set to the voter;
and wherein voting information of the voter is sent from the voting terminal to the voting process execution subsystem using the voting identification and the voting password;
and wherein confirmation information of the voter is sent from the voting terminal to the validation subsystem using the confirmation identification and the confirmation password in response to request by the validation subsystem to confirm his/her own voting information.

4. The system according to claim 3, wherein the voting process execution subsystem offers the voter to send the voting information to the voting process execution subsystem by electronic mail or at a site with a specific URL (Uniform Resource Locator) on the Internet, selectively.

5. The system according to claim 4, wherein an advertisement is displayable at the site.

6. An electronic voting system for use in an election, comprising:
voting terminals operably configured to permit voters to cast votes;
a voting process execution subsystem connected to the voting terminals;
the voting process execution subsystem receiving information of the votes sent from the voting terminals for vote counting operation;
a validation subsystem connected to the voting terminals;
the validation subsystem confirming the voting information of the votes, thereby judging validity of the votes;
a voting request management subsystem for requesting the voting process execution subsystem and the validation subsystem to execute voting process and validation process, respectively, and for receiving vote counting results and vote validation results from the voting process execution subsystem and the validation subsystem, respectively;
a database for storing vote-relating information including data about eligible voters;
the database being accessible by the voting process execution subsystem, the validation subsystem, and the voting request management subsystem.

7. An electronic voting method for use in an election, the method comprising the steps of:
notifying a voter to cast his/her vote from a voting terminal;
receiving voting information of a vote sent from the voting terminal; and
requesting the voter to confirm the voting information of his/her own vote sent from the voting terminal, thereby judging validity of the vote.

8. The method according to claim 7, further comprising the steps of:
(i) setting a voting identification and a voting password of the voter and notifying the voting identification and the voting password thus set to the voter;
(ii) setting a confirmation identification and a confirmation password of the voter and notifying the confirmation identification and the confirmation password thus set to the voter;
(iii) sending voting information of the voter from the voting terminal to a voting process execution subsystem using the voting identification and the voting password; and
(iv) sending confirmation information of the voter from the voting terminal to a validation subsystem using the confirmation identification and the confirmation password in response to request by the validation subsystem to confirm his/her own voting information.

9. The method according to claim 8, wherein the voting process execution subsystem offers the voter to send the voting information to the voting process execution subsystem by electronic mail or at a site with a specific URL (Uniform Resource Locator) on the Internet, selectively.

10. The method according to claim 9, wherein an advertisement is displayable at the site.
